(19) United States
(12) Patent Application Publication
(10) Pub. No.: US 2012/0173460 A1
(43) Pub. Date: Jul. 5, 2012

(54) MONEY TREE NETWORK

(76) Inventor: HOUSSAM Farouk TARABAY, Richmond, VA (US)

(21) Appl. No.: 12/806,205

(22) Filed: Jan. 3, 2011

(51) Int. Cl. G06Q 90/00

(52) U.S. Cl. 705/500

(57) ABSTRACT

Money tree network system works from people to people, each person who joins the system by paying a fee we call him/her a root, and his/her job is to bring two other persons to his/her tree, then the system will continue in the same way each person should bring two other persons to begin making money, in that way each one will have his own tree and each root (person) in his/her tree will give him/her a $1 monthly profit.

When his/her tree reaches a big number he/she will earn a lot of money from the system flow, and also they can use the website services that are created just for people in the system for free, and each person want to make more money he/she will be allowed to open more and more accounts by paying a fee for each account he/she should bring two new persons for each new account to build the tree, and to make the system achieve success we made a protection wall that will limit each tree at 1024 roots, that means each person can earn $1023 from each account he/she opens.

Money Tree Network is the easiest way for everyone to make easy money without spending hours working. The system is very easy, each individual will conquer a position in the money tree by paying a fee; all he/she has to do to start making money is to bring two individuals to also join the tree, each individual has to do the same thing and bring two people under his own tree.

Each individual can see how his tree is growing through the people he convinced to join the tree and others brought by these two people and so on.

All you need to do is put two persons under you in your tree and the system will flow and work buy itself.

The system works on this method 1×2=2×2=4×2=8×2=16×2=32×2=64×2=128 ext. . .

How to begin earning money:
Each individual involved in this system will pay $100 as a monthly payment
The two people brought by the first individual, we'll call him the initiative, will also pay $100 each
$50 from each person's payment will directly go to the initiative or individual who introduced them to the tree
The second generation of 4 people brought by the 2 individuals whom the initiative introduced to the tree will add $5 to his/her monthly payment
The third generation and so forth will add up $1 to the initiatives monthly payment.
All individuals enrolled who become in their turn initiatives will earn money the same way.

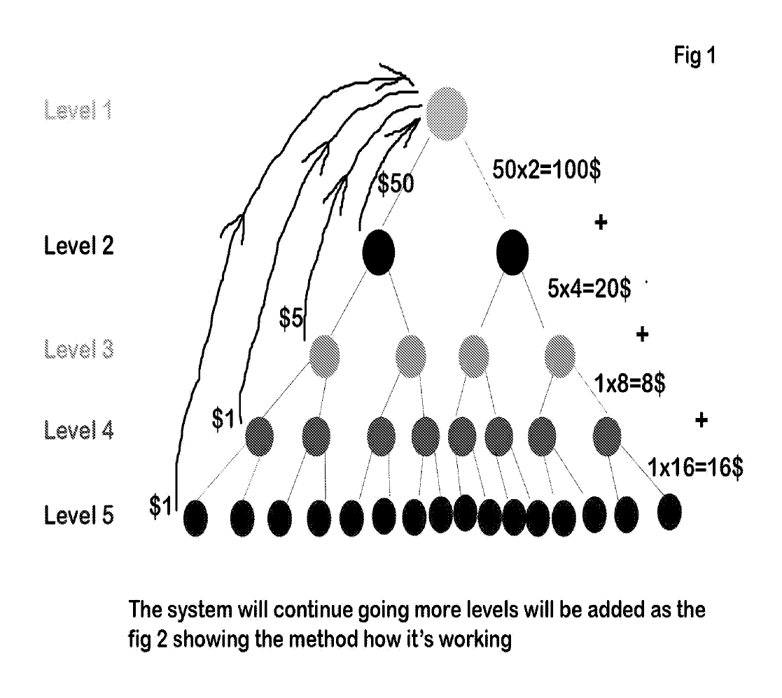

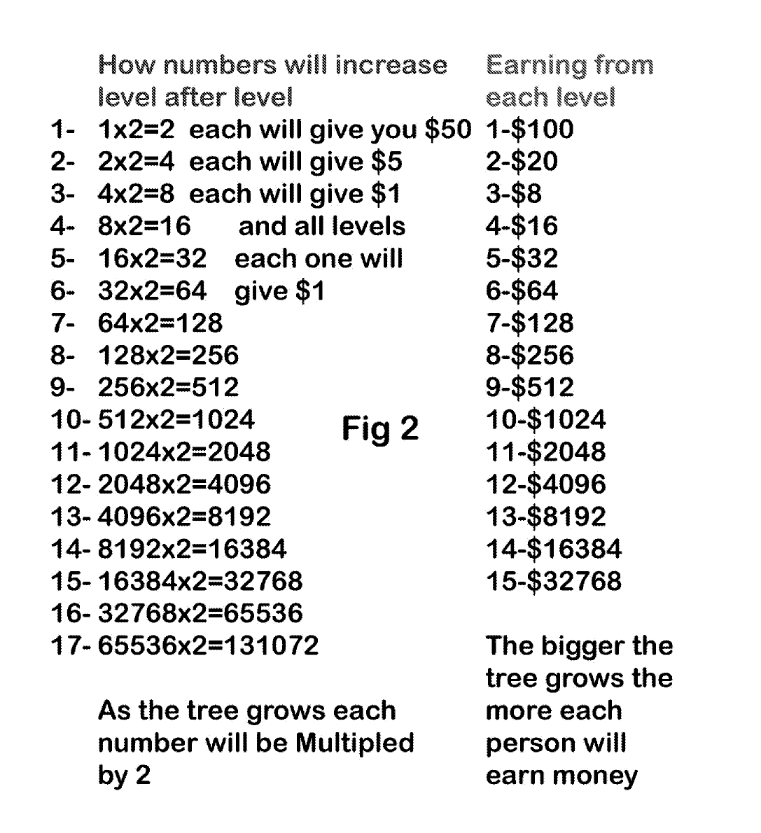

FIG. 1 will explain more.

Protection Program:

The Project will have a protection program this program will take its place in our system.

A protection wall is to be used in the future when the tree's reaches very high levels. When customers begin to earn more than $1000 per month, they will begin to pay 10% from their earning in addition to their monthly fee ($100). This 10% goes to the “Wall protection box” and when we are in highest levels and can't bring in more people to our tree we will begin to built our protection wall, the job of this wall is to protect the last level's with at least two wall levels; this way no one will lose money from customers of last level's on the contrary they will earn more money than what they are paying and this will make them continue with us and the system will stay in safe.

1. Web based Money network

2. Money network is a chain of interrelated individuals who earn money through bringing in other individuals to the network, forming their tree.

3. To join the network each individual pays a fee

4. To start earning money each individual must bring in 2 individuals (we call roots) to join the network and in their turn pay the fee.

5. As the individual brings his/her roots to the tree, he/she automatically starts earning money Not only from their roots but also as from roots of roots and so on.

6. The system flows from 1 individual who brings in 2 roots=1×2 to 2 individuals Who bring in 4 roots=2×4 and so on the tree grows and goes into stages as the number of individuals add up.

7. Company will protect its roots (trees) by a safety program called wall protection this wall created to protect latter the highest stages in the main tree and to ensure all participants in the tree earn money.

8. The wall will be built upon blocks which are %10 taken from each individual earning more than a $1000 towards protecting the network and ensuring endless money flow in the tree.
